(19) United States
(12) Patent Application Publication
(10) Pub. No.: US 2023/0059855 A1
(43) Pub. Date: Feb. 23, 2023

(54) Lee Drive 4 Turbine

(71) Applicant: WALTER L GLOVER, GRIFFIN, GA (US)

(72) Inventor: WALTER L GLOVER, GRIFFIN, GA (US)

(21) Appl. No.: 16/706,208

(22) Filed: Dec. 6, 2019

(51) Int. Cl. F03B 17/06; F03B 13/08

(52) U.S. Cl. CPC F03B 17/06; F03B 13/08; F05B 2260/503; F05B 2260/504

(57) ABSTRACT

A gravity, leverage, fluid or liquid driven multiple side by side cylinder high or low head turbine, each side by side cylinders comprises 1, an output center shaft with attached drive gears, 2, length of a lever with a fulcrum along its length, container at one end of said lever and cable attached at opposite end of said lever on one side of said fulcrum, one side by side cylinder with container in of lever in the up position and said cable end of lever in the down position, other side by side cylinder has its container end in the down position with its cable end in the up position, cable over pulleys one end of said cable attached to of side by side cylinder's said container end lever for one dropping water in container end of lever to pull up its side by side cylinder's empty container end of lever, body of said attached to cable end of said levers is around down positioned pulley with opposite in of said cable attached to a rack gear, said rack gear's teeth mashed with the teeth of a pinion gear, said pinion gear is attached to a set of blocks, said set of blocks and attached pinion gear rotate around a section of said center shaft and at least one of its attached drive gears, mounted to said set of blocks is a said section of center shaft's attached drive gear's motor or spring driven drive wedge, volumes of water dropped into number of cylinder's containers on levers in the up position dropping at the acceleration of gravity generating torque through cable end of lever, said cable, rack gear, pinion gear, section of center shafts drive gear, center shaft and its drive gears to the input shaft attached gear of a device or mechanism, said input shafts attached gear diameter maybe equal to or less than the diameter of said center shaft attached drive gear who teeth are mashed with said input shaft attached gear.

### BACKGROUND OF THE INVENTION

The Lee Drive 4 Turbine a water driven is designed with multiple side by side cylinder's which generates rpm and torque. The torque and the rpm can drive the gear attached to a megawatt generator shaft or the gear attached to the input shaft of a gearbox of a gearbox/megawatt generator unit to rotate so said shafts said gearbox's and its megawatt generator's components of said unit components rotate as said megawatt generator generates megawatt of energy and the other megawatt generator's shaft and said megawatt generator's components rotate so said megawatt generators generate megawatts of energy, The Lee Drive 4 Turbine's cylinders uses mechanical advantage created by leverage of a length of lever with a fulcrum and a volume of water within said levers container end of said lever on one side of said lever's fulcrum as a number of said cylinder's said water filled container end of lever is simultaneously dropping to generate torque.

The Lee Drive 4 Turbine a water driven is designed with every other side by side cylinder's lever's container end is in the up position so that said containers are over their water delivery tubes and its non-container end is in the down position and said cylinder's rack gear is in the down position with the top teeth of said rack gear mashed with the teeth of said cylinder's pinion, the remaining cylinders have their container end of lever in the down position with the non-container end of said lever in the up position and said cylinder's rack gear in the up position and said rack gear's bottom teeth mashed with said cylinder's pinion gear.

Each set of side by side cylinder's container end of lever's may have a counterbalance system working between two side by side cylinders as one cylinder's water filled container end of said lever drops a cable attached to both cylinder's container end of lever pulls around top platform mounted pulleys as one end of said cable lift the adjacent cylinder's empty container end on one side of said levers fulcrum up. Side by side cylinder's rack gears also may have a counterbalancing rack gear pulling down system. as one cylinder's water filled container end of lever drops and its non-container end rises pulling up said cylinder's rack gear a cable attached to the bottom of said rising rack is pulled around lower mounted pulleys which said cables opposite end pulls down the adjacent cylinder's rack gear.

Each set of side by side cylinder's container end of lever's may have a chain and sprocket counter balancing system where one of two cylinders have one end of chain attached to its container end of a lever in the up position and the adjacent cylinder's container end of lever in the down position. As water is dropping into the cylinder's container on the end of a lever in the up position and the levers end drops the chain is pulled around the turbines top platforms mounted sprockets pulling the adjacent cylinder's empty container end lever in the down position up.

Each set of side by side cylinder's container end of lever's may have a pivoting lever counter balancing system where one of two cylinders have one end of a rod attached to its container end of a lever in the up position and the rod's opposite end is attached to one side of a pivoting lever the lever pivots on a spindle in its middle. The rod attached to the other end of said pivoting lever opposite end is attached to the adjacent cylinder's container end of lever in the down position. As water is dropping into the cylinder's container on the end of a lever in the up position and the levers end drops under the weight of the within said container the pivoting lever pivots on said spindle as one rod end is pulled down and the other rod rises pulling the adjacent cylinder's empty container end of lever in the down position up

The curved lever low head version of our multiple side by side cylinder water driven turbine when a water tank with bottom attached water delivery tubes is staged on the turbine's upper platform, a water capture tank is staged below said multiple side by side cylinder turbine and said multiple side by side cylinder turbine, water tank and water capture tank together are staged near a low head dam with gates, low head non energy producing dam with gates or waterfall. Placing a water capture tank with a bottom pipe with a motor driven valve in the water flowing over a waterfall and attached said water capture tank to the gates of a dam. Said water delivery tubes have upper and lower motor driven valves. The water flowing over the open gates of a dam or flowing over a waterfall flows into a said water capture tank with the bottom pipe. Said bottom pipe feed gravity fed into said water tank above our multiple side by side cylinder water driven turbine's. Each water delivery tube is above each cylinder's container, when said container is mounted on spindles which are attached to one end of a cylinder's lever on one side of said lever's fulcrum, said lever's container end is in the up position. The water in the tank attached to the gates or in the water flowing over the waterfall above our multiple side by side cylinder water driven turbine is gravity fed down through said pipe and into the water tank above our multiple side by side cylinder water driven turbine.

Each cylinder's lever has a container which rotate on said lever's spindles at one end of said lever on one side of said levers fulcrum (said lever's the longer end) and a cable attached to said lever's non-container end on the other side of said lever's fulcrum (said lever's shorter end). With every other side by side cylinder's empty container end of lever in the up position and with said lever's empty container over their water filled water delivery tube and said lever's non-container end in the down position and the other side by side cylinder's empty container end of lever in the down position and said lever's non-container end in the up position.
1. All of the water tank's water delivery tube's bottom valve's motor is signaled to rotate which closes said water delivery tube's bottom valve. said water delivery tube's top valve's motor is signaled to rotate which opens said top valve, water from said water tank fills said delivery tubes. said water delivery tube's top valve's motor is signaled to rotate as said top valves close.
2. On a set number of the cylinder's the drive wedge's motor is signaled to rotate which pushes down the drive wedge as their points are pushed down between the teeth of their section of the center shaft's attached drive gears.
3. On said set number of the cylinder's containers are over their water delivery tubes, the motors on said number of water delivery tubes rotates and said water delivery tubes bottom valve opens the volumes within said water delivery tubes drops down into said container over them.
4. said set number of cylinder's water filled container and their end of lever on one side of said lever's fulcrum drops down generating torque minus drag as said set number of dropping lever's non-container ends rises up through their roll guides pulling one end of a cable up. Said cable's body is pulls around lower mounted pulleys and then around upper platform mounted pulleys the opposite end of said cable is attached to the top of said set number of cylinder's rack gears.
5. Said cable pulls said set number of cylinder's rack gears up through their roller guides, the teeth of said set of number cylinder's pulled up rack gears mash with the teeth of said set number of cylinder's pinion gear. Said pinion gears is attached to one side of set of blocks. Said pinion gears and its set of blocks rotate around said section of said turbine's center shaft.
6. With said drive wedge's point between section of said center shaft's attached drive gear's teeth said turbine's center shaft and its drive gears rotate.
7. Simultaneously
   a, cable attached to said set number of cylinder's dropping container end of lever is pulled around upper platform mounted pulleys with the opposite end of said cable attached to said set number of adjacent cylinder's set number of empty container end of lever in the down position. Said cable pulls said adjacent set number of cylinder's levers and their empty container end in the down position up such that said empty containers will be over their water filled water delivery tubes. Said empty Container's bottom doors close.
   b. the cable attached to the bottom of each said set number of cylinder's rising rack gears is pulled around their bottom mounted pulleys with the opposite end of each said cable attached the bottom of to each set number of said adjacent cylinder's rack gears in the up position. said cable pulls down said adjacent set number of cylinder's rack gears through their roller guides. With the teeth of said pulling down rack gears mash with the teeth of one adjacent side by side cylinder's pinion gears, each pinion gears is attached to their set of blocks. With said set number of adjacent cylinder's section of center shafts drive gear's drive wedge motor is signaled to rotate as said motor pulls said drive wedge's point out of said drive gears, said pinion gears and their set of blocks rotate in reverse around said section of center shafts.
   c. one of said turbines rotating center shaft's attached larger diameter drive gear's teeth mash with the teeth of the smaller diameter gear attached to the input shaft of a gearbox of a gearbox/MW generator unit or the input shaft of a MW generator. Said gearbox/MW generator unit's gearboxes components and said MW generators of gearbox/MW generator unit's components rotate. Said MW generator of gearbox/MW generator unit's generates megawatts of energy. Said MW generators components rotate Said MW generator generates megawatts of energy.
8. said empty water delivery tube's bottom valve's motor is signaled to rotate and said bottom valve close and the top valve's motor is signaled to rotate and said top valves opens on set number of cylinder's empty water delivery tubes water drops down from said water tank and refills said empty water delivery tubes.
9. prior to said first set number of cylinder's dropping levers and their water filled containers drop to their bottom out point where said water filled container's bottom door's opening mechanism contacts their opening arm said bottom open and the water within said container drops out a second set number of cylinder's water filled water delivery tubes bottom valve motors are signaled to rotate said bottom valves open and the water within said water delivery tubes drops down and fills said set number of cylinder's containers on their levers in the up position, said set number of cylinder's container of water and the their lever ends on one side of their fulcrum drop maintaining the turbine's rotation and increasing the turbine generated torque minus drag.
10. as said set number of cylinder's dropping water filled container drop to a bottom out point said container's bottom door's opening mechanism contacts their opening arm said bottom doors open and the water within said containers drops out and is captured and drains into the receiver water below the dam or waterfall. The process continues from process #5.
11. prior to the second set of water filled container end of lever drops to their bottom out point where said water filled container's bottom door's opening mechanism contacts their door opening arm said bottom doors open and the water within said container drops out a third set number of cylinder's water filled water delivery tubes bottom valve motors are signaled to rotate said bottom valves open and the water within said water delivery tubes drops down and fills said set number of cylinder's containers on their levers in the up position, said set number of cylinder's container of water and the their lever ends on one side of their fulcrum drop maintaining the turbine's rotation and increasing the turbine generated torque minus drag. The process continues from process #5.

The process continues and repeats to generate torque and rpm which drive at least one megawatt generator to generate megawatts of energy.

The turbine generated torque generated=the weight of the volume in the containers time the length of the section of the container of water's lever from the fulcrum to said lever's container of water time the number of cylinder's water filled containers and their levers which are simultaneously dropping minus drag.

The rpm turbine generated by the turbine=the distance the water filled container end of levers are dropping minus drag.

The turbine generated rpm can be increased by the diameter of the center shafts attached drive gear to a smaller diameter gear attached to the input shaft of the device which said canter shaft's attached drive gear is mashed with if the both have the pitch.

### BRIEF SUMMARY OF THE INVENTION

The Lee Drive 4 Turbine is designed with multiple side by side cylinder's and said cylinder's container end of lever on one side of said lever's fulcrum counterbalance and lifts one another each other and the side by side cylinder's rack gears counterbalance and pulls down each other rack gear this can be accomplished by either of the following three method:

a cable attached to both cylinder's container end of lever with the body of said cable around upper platform mounted pulley so as water is dropped in one cylinder's container on the end of its lever and said container and its lever end drops the cable pulls around upper platforms attached pulleys as the opposite end of said cable pulls the adjacent cylinder's empty container end which is in the down position up. The same cable system works for the cylinder's rack gears, as one cylinders dropping end of lever is dropping its non-container end rise pulling said cylinder's rack gear up, as said cylinder's rack gear rises it pulls one end of a cable up around lower mounded pulleys as said cables opposite end pulls down the adjacent cylinder's rack gear.

A chain and sprocket counter balancing system where one of two cylinders have one end of chain attached to its container end of a lever in the up position and the adjacent cylinder's container end of lever in the down position. As water is dropping into the cylinder's container on the end of a lever in the up position and the levers end drops the chain is pulled around the turbines top platforms mounted sprockets pulling the adjacent cylinder's empty container end lever in the down position up.

A pivoting lever counter balancing system where one of two cylinders have one end of a rod attached to its container end of a lever in the up position and the rod's opposite end is attached to one side of a pivoting lever the lever pivots on a spindle in its middle. The rod attached to the other end of said pivoting lever opposite end is attached to the adjacent cylinder's container end of lever in the down position. As water is dropping into the cylinder's container on the end of a lever in the up position and the levers end drops under the weight of the within said container the pivoting lever pivots on said spindle as one rod end is pulled down and the other rod rises pulling the adjacent cylinder's empty container end of lever in the down position up

The Lee Drive 4 multiple cylinder turbine uses mechanical advantage of leverage (the distance of a section of a lever from its fulcrum to its container of water on one side of said lever's fulcrum). Our water driven Lee Drive 4 multiple cylinder low head or high head turbine generates torque in that a number of cylinder's dropping levers and their container of water on one side of said lever's fulcrum times the weight of said water in number of water filled container simultaneously dropping times the length of said section of said levers from their container of water minus said lever's non-container length. Compared to the massive volume of water falling from highs which drive the large 70 ton Francis turbines along not considering the torque requires by the megawatt generator.

Our levers are counterweighted by the cables running from one cylinder's dropping water filled container end of their levers in the up position which are dropping to the adjacent side by side cylinder's empty container of lever in the down position.

Also our turbine has the cable attached to the bottom of each side by side cylinder's rack gears. One side by side cylinder with the dropping lever and its container of water rack gear in the down position rising and the adjacent cylinder's rack gear in the up position in the cable is pulling down this off set the massive weight of the Frances turbine allowing our turbine to use much less water using gravity to drop from lower heads in to our turbine containers while generating the require amounts of torque.

Our curved lever or lever's step-down container end of lever and curved lever or lever's step-down non-container ends of a lever allow our turbine to use water from many of the non-energy producing low head dam and waterfalls to generate rpm and torque which drive megawatt generators to generate megawatts of energy using the water from low head dams and waterfalls, many of the non-energy producing dams as well.

Out curved levers allows for very long container end of levers on one side of said lever's fulcrum with shorter non-container ends of lever which allows use to use much less water in said containers fall from low head dams and waterfalls to generate massive amounts of torque and drive larger Megawatt generators or gearbox/megawatt generator units to generate megawatts of energy.

### DETAILED DESCRIPTION OF THE INVENTION

The Lee Drive 4 Turbine is designed with multiple side by side cylinder's and said cylinder's container end of lever on one side of said lever's fulcrum counterbalance and lifts one another each other and the side by side cylinder's rack gears counterbalance and pulls down each other rack gear this can be accomplished by either of the following three method:

a cable attached to both cylinder's container end of lever with the body of said cable around upper platform mounted pulley so as water is dropped in one cylinder's container on the end of its lever and said container and its lever end drops the cable pulls around upper platforms attached pulleys as the opposite end of said cable pulls the adjacent cylinder's empty container end which is in the down position up. The same cable system works for the cylinder's rack gears, as one cylinders dropping end of lever is dropping its non-container end rise pulling said cylinder's rack gear up, as said cylinder's rack gear rises it pulls one end of a cable up around lower mounded pulleys as said cables opposite end pulls down the adjacent cylinder's rack gear.

A chain and sprocket counter balancing system where one of two cylinders have one end of chain attached to its container end of a lever in the up position and the adjacent cylinder's container end of lever in the down position. As water is dropping into the cylinder's container on the end of a lever in the up position and the levers end drops the chain is pulled around the turbines top platforms mounted sprockets pulling the adjacent cylinder's empty container end lever in the down position up.

A pivoting lever counter balancing system where one of two cylinders have one end of a rod attached to its container end of a lever in the up position and the rod's opposite end is attached to one side of a pivoting lever the lever pivots on a spindle in its middle. The rod attached to the other end of said pivoting lever opposite end is attached to the adjacent cylinder's container end of lever in the down position. As water is dropping into the cylinder's container on the end of a lever in the up position and the levers end drops under the weight of the within said container the pivoting lever pivots on said spindle as one rod end is pulled down and the other rod rises pulling the adjacent cylinder's empty container end of lever in the down position up.

The Lee Drive 4 Turbine's cylinders uses mechanical advantage created by leverage of a length of lever with a fulcrum and a volume of water within said levers container end of said lever on one side of said lever's fulcrum as a number of said cylinder's said water filled container end of lever is simultaneously dropping to generate torque.

The curved lever low head version of the Lee Drive 4 multiple side by side cylinder water driven turbine when staged near a low head dam, low head non energy producing dam or waterfall and a water tank with bottom attached water delivery tubes. Said water delivery tubes have upper and lower motor driven valves is set above our multiple side by side cylinder water driven turbine. The water flowing over the open gates of a dam or flowing over a waterfall flows into a tank with a bottom pipe which is staged above our multiple side by side cylinder water driven turbine's water tank. Each water delivery tube is above each cylinder's container when said container is in the up position. The water in the tank above our multiple side by side cylinder water driven turbine is gravity fed down through said pipe and into the water tank above our multiple side by side cylinder water driven turbine. Each cylinder's lever has a container which rotate on said lever's spindles at one end of said lever on one side of said levers fulcrum (the longer end) and a cable attached to said lever's non-container end on the other side of said lever's fulcrum (the shorter end). With every other side by side cylinder's container end of lever in the up position and with said lever's empty container over their water delivery tube and said lever's non-container end in the down position and the other side by side cylinder's empty container end of lever in the down position and said lever's non-container end in the up position.
1. All of the water tank's water delivery tube's bottom valve's motor is signaled to rotate which closes the water delivery tube's bottom valve. said water delivery tube's top valve's motor is signaled to rotate which opens the top valve water from the water tank fills said delivery tubes. said water delivery tube's top valve's motor is signaled to rotate as the top valves close.
2. On a set number of the cylinder's the drive wedge's motor is signaled to rotate which pushes down the drive wedge as their points are pushed between the teeth of their section of the center shaft's attached drive gears.
3. On said set number of the cylinder's containers are over their water delivery tubes, the motors on said number of water delivery tubes rotates and said water delivery tubes bottom valve opens the volumes within said water delivery tubes drops down into said container over them.
4. said set number of cylinder's water filled container and their end of lever on one side of said lever's fulcrum drops down through their roller guides generating torque minus drag as said dropping lever's non-container ends rises pulling one end of a cable up. Said cable's body is pulls around lower mounted pulleys and then around upper platform mounted pulleys the opposite end of said cable is attached to the top of said set number of cylinder's rack gears.
5. Said cable pulls said set number of cylinder's rack gears up their roller guides, the teeth of said set of number cylinder's pulled up rack gears mash with the teeth of said set number of cylinder's pinion gear. Said pinion gears is attached to one side of set of blocks. Said pinion gears and its set of blocks rotate around said section of said turbine's center shaft.
6. With said drive wedge's point between section of said center shaft's attached drive gear's teeth said turbine's center shaft and its drive gears rotate.
7. Simultaneously
   a, cable attached to said set number of cylinder's dropping container end of lever is pulled around upper platform mounted pulleys with the opposite end of said cable attached to said set number of cylinder's side by side set number of cylinder's empty container end of lever in the down position. Said cable pulls said side by side set number of cylinder's levers and their empty container end up such that said empty containers are over their water filled water delivery tubes. Said empty Container's bottom doors close.
   b. the cable attached to the bottom of each said set number of cylinder's rising rack gears is pulled around their bottom mounted pulleys with the opposite end of each said cable attached the bottom of to one adjacent side by side set number of cylinder's rack gears. said number of cylinder's rack gears are in the up position. said cable pulls down said set number of cylinder's rack gears, with the teeth of said rack gears mash with the teeth of one adjacent side by side cylinder's pinion gears, each pinion gears is attached to their set of blocks. With said set number of adjacent cylinder's section of center shafts drive gear's drive wedge motor is signaled to rotate as said motor pulls said drive wedge's point out of said drive gear said pinion gears and their set of blocks rotate in reverse around said section of center shafts.
   c. one of said turbines rotating center shaft's attached larger diameter drive gear's teeth mash with the teeth of the smaller diameter gear attached to the input shaft of a gearbox/MW generator unit or the input shaft of a MW generator. Said gearbox/MW generator unit's gearboxes components and said MW generators components rotate. Said MW generator generates megawatts of energy. Said MW generators components rotate Said MW generator generates megawatts of energy.
8. The bottom valve is signaled motor to rotate and said bottom valve close and the top valve's motor is signaled to rotate and said top valves opens on set number of cylinder's empty water delivery tubes water drops down and refills said water delivery tubes.
9. prior to said set number of cylinder's dropping levers and their water filled containers drop to their bottom out point a second set number of cylinder's water filled water delivery tubes bottom valve motors are signaled to rotate said bottom valves open and drops down from said water tank and water filled said set number of cylinder's containers, said set number of cylinder's container of water and the their lever ends on one side of their fulcrum drop maintaining the turbine's rotation and increasing the turbine generated torque.
10. as said set number of cylinder's dropping water filled container drop to a bottom out point said container's bottom door's opening mechanism contacts their door opening arm said bottom doors open and the water within said containers drops out and is captured and drains into the receiver water. The process continues and repeats to generate megawatts of energy.

The turbine generated torque generated=the weight of the volume in the containers time the length of the section of the container of water's lever from the fulcrum to said lever's container of water time the number of cylinder's water filled containers and their levers which are simultaneously dropping minus drag.

The rpm turbine generated by the turbine=the distance the water filled container end of levers are dropping minus drag.

The turbine generated rpm can be increased by the diameter of the center shafts attached drive gear to a smaller diameter gear attached to the input shaft of the device which said canter shaft's attached drive gear is mashed with if the both have the pitch.

The turbine is designed with every other cylinder's container end of lever is in the up position with their non-container end in the down position and their rack gear in the down position. The teeth of said rack gear mash with the teeth of said cylinder's pinion gear. The other side by side cylinder's empty container end is in the down position with its non-container end in the up position and said cylinder's rack gear is in the up position with the bottom teeth of said rack gear mashed with the teeth of said cylinder's pinion gear.

Out turbine is designed with side by side cylinder's and said cylinder's lever's counter balance each other and the side by side cylinder's rack gears counter balance each other this can be accomplished by either of the following three method: a cable attached to both cylinder's container end of lever with the body of said cable around upper platform mounted pulley so as water is dropped in one cylinder's container on the end of its lever and said container and its lever end drops the cable pulls around upper platforms attached pulleys as the opposite end of said cable pulls the adjacent cylinder's empty container end which is in the down position up. The same cable system works for the cylinder's rack gears, as one cylinders dropping end of lever is dropping its non-container end rise pulling said cylinder's rack gear up, as said cylinder's rack gear rises it pulls one end of a cable up around lower mounded pulleys as said cables opposite end pulls down the adjacent cylinder's rack gear.

One example of our low head twenty side by side cylinder water driven turbine 10-megawatt energy system staged near a non-energy producing 35 foot tall dam with four gates follows. We've attached water collection tanks to the top of each gate. Each water tanks have a bottom pipe with a motor drive valve. When the gates open water from said dam's reservoir fills said water tanks.

A water tank with bottom attached water deliver tubes is attached to the turbine's top platform and a water capture tank is staged under said turbine. Said water delivery tubes have top and bottom motor driven valves. The bottom of each water deliver tube is above each cylinder's containers. When said cylinder's lever is in the up position their empty close bottom containers are over their water delivery tubes. Said water collection tanks bottom pipes feed gravity fed water into the top of the turbine top platform mounted water tank.

Each cylinder has the following components:
1. sixty-four feet long levers with said lever's container end of said lever on one side of said fulcrum being sixty feet long and the non-container end of said lever being 14 feet long.
2. The turbines three-foot diameter center shaft's attached drive gears are four foot in diameter.
3. The rack gears are fourteen feet long with said rack gear's teeth mashed with the teeth of four-foot diameter pinion gears. Said pinion gears are attached to one side of a set of blocks. Said set of blocks have said center shaft's attached four foot diameter drive gears drive wedge mounted on said set of blocks a spring maintains the point of said drive wedge is within said drive gears when said pinion gears and their set of blocks rotate in one direction around their section of said turbines center shaft and said spring allows said drive wedge to float over said rotating drive gears when said rack gear are pulled down their roller guides and said pinion gears and their set of blocks rotates in reverse.

The process
1. The water collection tank's bottom pipe's valve's motor is signaled to rotate and said valve opens water flows through said pipe and down into said water tank mounted on the upper platform above said turbine.
2. With the water delivery tubes bottom valve closed the top valve motors are signaled to rotate on all of the water delivery tubes top valves opens. 1000 gallons of water from said water tank fills said water delivery tubes. The top valve motors are signaled to rotate on all of the water delivery tubes top valves close.
3. A signal is simultaneously sent to the bottom valves motors of five sets of cylinder's with empty container on their sixty four foot section of lever which are up on one side of their fulcrum with said empty container over their water delivery tubes to rotate and said bottom valves open. Said 1000 gallons of water drops down into said five cylinder's empty containers.
4. Simultaneously
5. said sixty four foot section of lever with their container's containing 1000 gallons of water drop at the acceleration of gravity minus drag generating 2,000,000 lb-ft of torque minus drag through said cylinder's dropping lever's non-container, cables, rack gears, pinion gears, set of blocks drive wedge said center shaft and its attached drive gears, 18″ diameter gear attached to the input shaft of a 2 to 1 ratio gearbox, said gearboxes output/10 MW generator said gearboxes components and said 10 MW generators components rotate as said 10 megawatt generator generate 10 megawatts of energy.
   (torque=sixty four— 14 feet)=50 ft. 50 ft.×(8 lbs, ×1000 gallons)=50×8000 lbs.×(5 dropping lever)=2,000,000 lb-ft of torque minus drag.
6. A signal is simultaneously sent to the bottom valve's motors of five sets of cylinder's empty water delivery tubes to rotate said bottom valve close. simultaneously a signal is sent the top said five empty water delivery tube's top valves motor to rotate said valves open and water from said water tank refills said five empty water delivery tubes. A signal is sent to said top valves motor of said five water delivery tube's top valves said motor rotates said top valves close.
7. The non-container end of said dropping levers rise pulling one end of a cable up the body of said cable is around a lower mounted pulley and then around said upper platform mounted pully with the opposite end of said cable attached to said cylinders rack gears.
8. Said five cylinders rising rack gears teeth mash with said five cylinder's pinion gears. Said five cylinder's drive gear drive wedge's point is pulled into the teeth of each cylinder's drive gear attached to a section of said center shaft. Said pinion gear's and their attached set of blocks rotate around said section of said center shaft as said center shaft and it attached drive gears rotate.
9. The cable attached to said five cylinder's dropping water filled container end of lever is pulled around said top platform mounted pulley as said cable's opposite end pulls the adjacent five cylinder's empty container end of levers in the down position up. The bottom doors of said pulled up empty container closes. Said five cylinder's pulled up lever's and their empty stop when said empty containers are over their water filled water delivery tubes.
10. Prior to said five cylinder's dropping container drop to their set point where said container's bottom door's opening mechanism contacts their door opening arm said bottom doors open and the water within said container drops out a second set of five cylinder's over their water filled water delivery tubes a signal is sent to the top valve motors to rotate said 1000 gallons of water within said water delivery tubes drops down into the empty container over said water filled delivery tubes.
11. Simultaneously said sixty four foot section of lever with their container's containing 1000 gallons of water drop at the acceleration of gravity minus drag generating 2,000,000 lb-ft of additional torque minus drag through said cylinder's dropping lever's non-container, cables, rack gears, pinion gears, set of blocks drive wedge said center shaft and its attached drive gears, 18″ diameter gear attached to the input shaft of a 2 to 1 ratio gearbox, said gearboxes output/10 MW generator said gearboxes components and said 10 MW generators components rotate as said 10 megawatt generator generate 10 megawatts of energy.
12. Said first said five sets of cylinder's dropping containers and levers drop to the set point and said containers bottom door's opening mechanism contacts their door opening arm said bottom doors open and the 1000 gallons of water within said five containers drops out and is capture in the water capture tank below said turbine. Said captured water drains through our perforate drainpipe which is staged along the top of the receiver water this reduce erosion.
13. A third set of five cylinder's water delivery tubes bottom valve motors are signaled to rotate said bottom valves open as said water delivery tubes 1000 gallons of water drop down into said five cylinders empty containers over said water delivery tubes. Said five cylinder's water filled container and their lever end drop at the acceleration of gravity minus drag which maintains the 4,000,000 lb-ft of torque minus drag through said turbines components, gearbox/10 MW generator unit as said 10 MW generator generates 10 MW of energy.
14. A signal is simultaneously sent to the bottom valve's motors of five sets of cylinder's empty water delivery tubes to rotate said bottom valve close. simultaneously a signal is sent the top said five empty water delivery tube's top valves motor to rotate said valves open and water from said water tank refills said five empty water delivery tubes. A signal is sent to said top valves motor of said five water delivery tube's top valves said motor rotates said top valves close.
15. the process repeats from procedure #7.

For this sample process the water filled container end of said five cylinders will drop such that the non-container rises 12.56 feet which turns the 4 foot diameter drive gears one revolution. Lets assume that the water filled container of lever will drop 15 feet which will take 0.97 seconds. This is equal to 61.9 rpm of the four foot diameter drive gears. The four foot diameter drive gear which is driving the 18 inch diameter gearboxes input shafts gear will reach a rpm equal to 61.9 rpm×(48 inch/18 inch)=61.9×2.66=165.06 rpm. The 10 MW generator requires 900 rpm therefore the gearbox ratio must be 6 to 1.

### BRIEF DESCRIPTION OF THE SEVERAL VIEWS OF THE DRAWING

The accompanying drawings, which are incorporated in and form a part of this specification, illustrate the embodiments of the fluid or liquid driven The Lee Drive 4 multiple cylinder turbine and together with the description, explain the principles of this application.

FIG. 1 depicts perspective top view: of the preferred embodiment of four cylinders of our curved lever low head water driven version of our water driven multiple cylinder turbine with the following components:

A=the container end of the curved lever. A2=A2=container end of curved lever lifting cable. A3=non-container end of curved lever. A4=curved lever's roller guide. B=rack gear. B2=rack gear lifting cable. Z=rack gear roller guides.
C=containers. D=set of blocks. D2=pinion gear. D4=lower mounted pulley. D5=upper planted mounted pulley. G=center shaft. G2=center shafts attached drive gears. GB=gearbox. GN=megawatt generator. GG=gearbox input shaft attached gear. SD=spindle. F=fulcrum. R=support. SP=upper platform. M=drive wedge lift and lowering motor.

FIG. 1A side view AA depicts perspective: of the preferred embodiment of one cylinder of The Lee Drive 4 multiple cylinder water driven turbine with the following components:

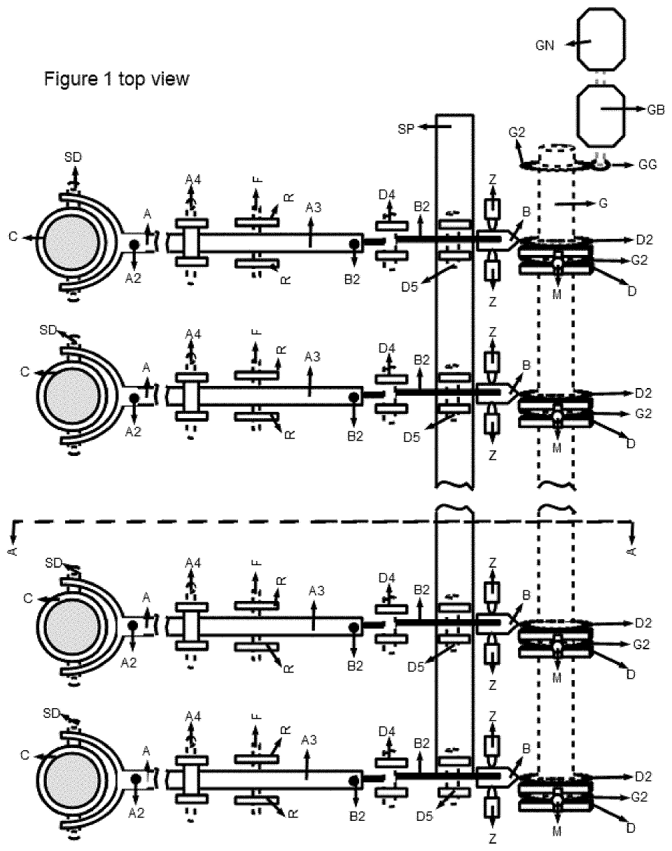

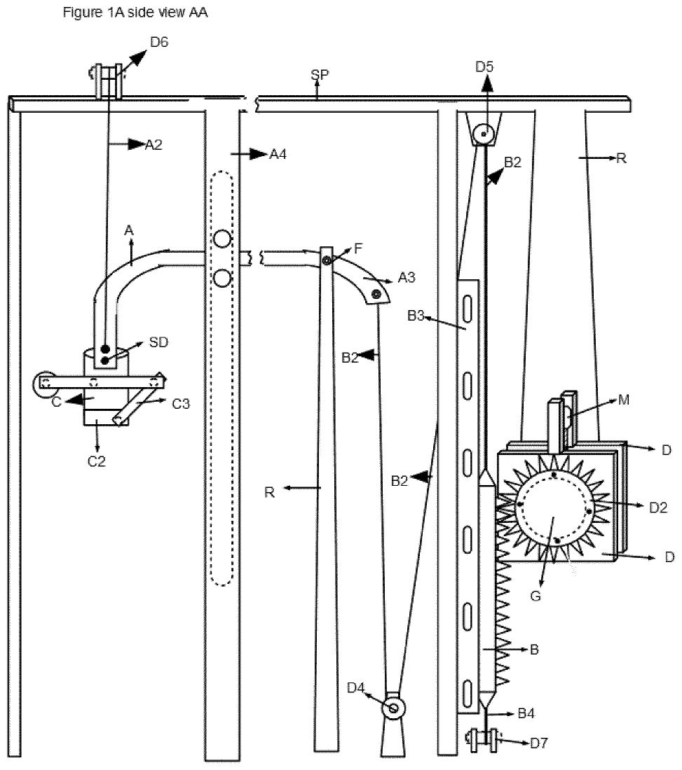

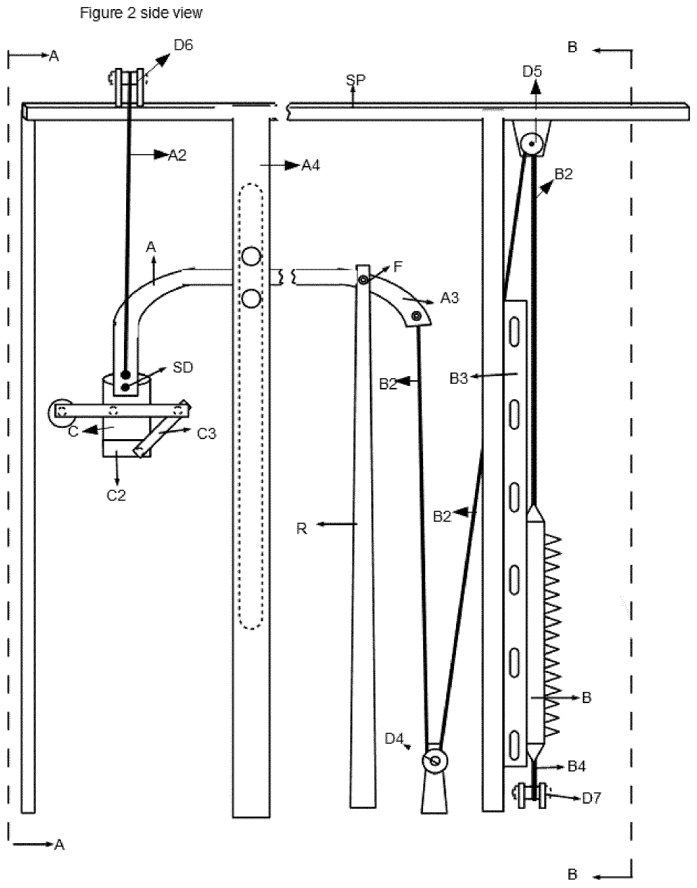

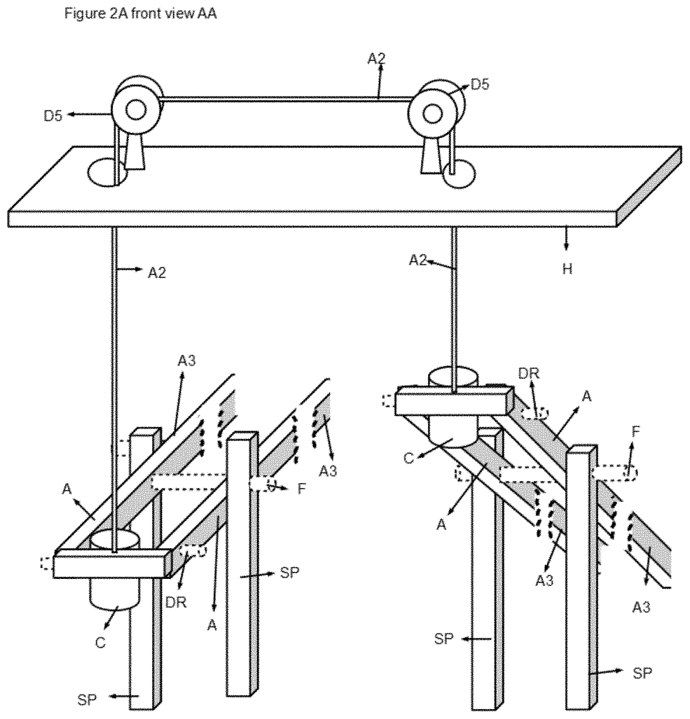

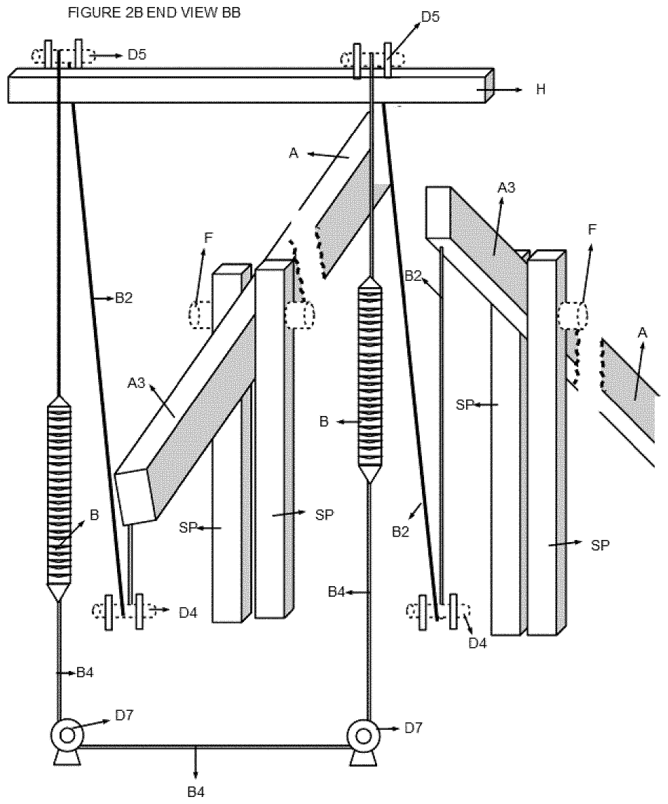

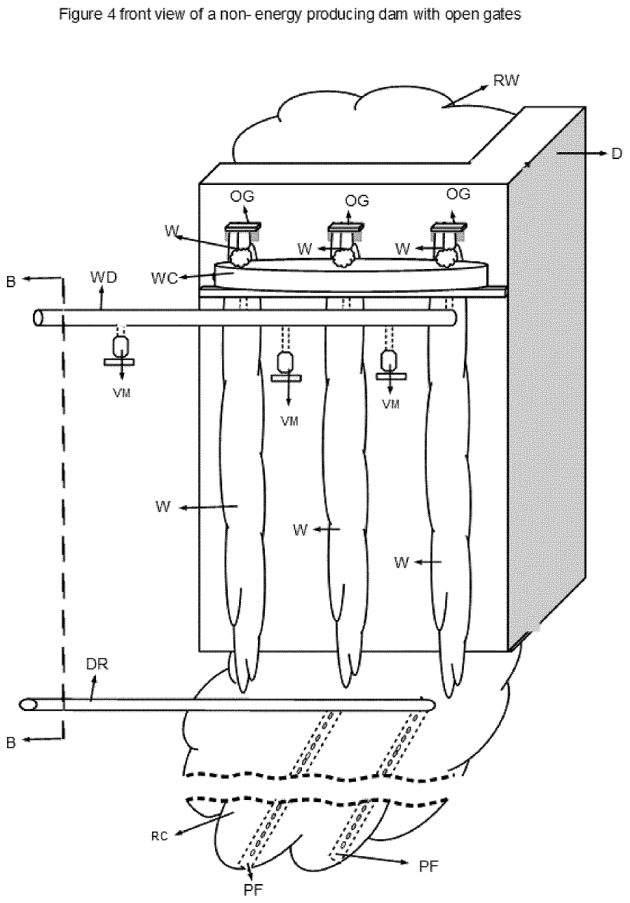

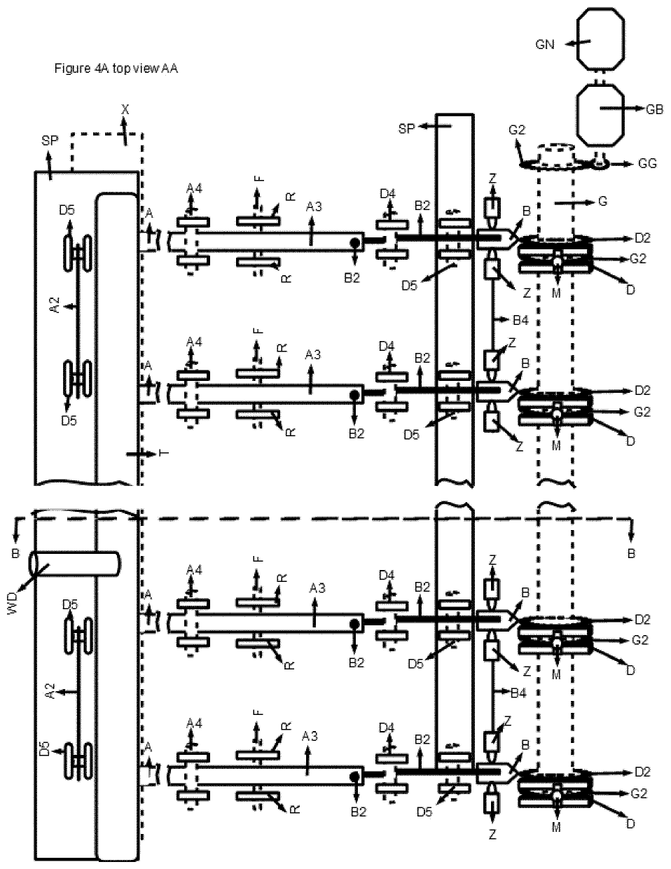

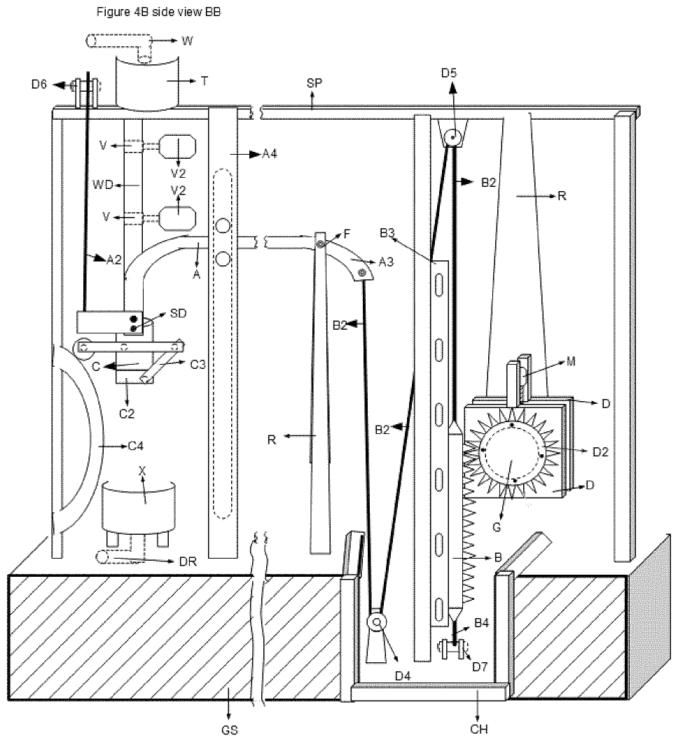

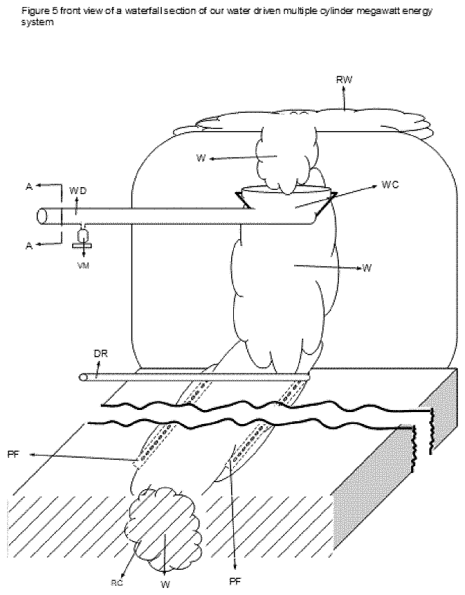

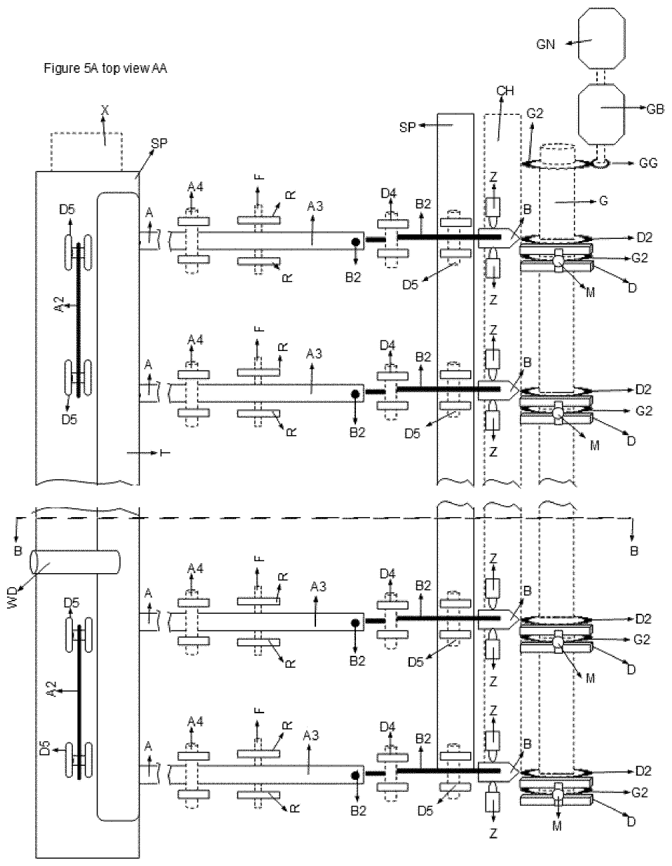

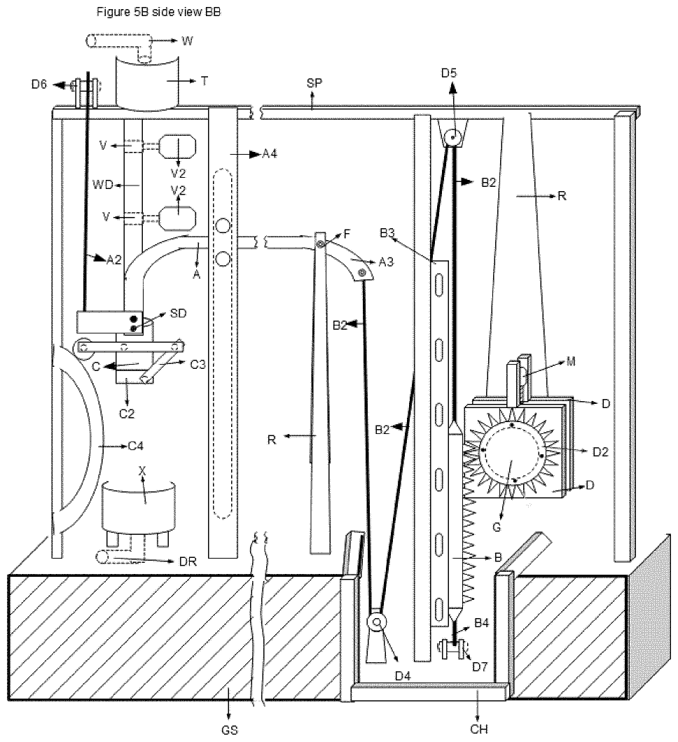

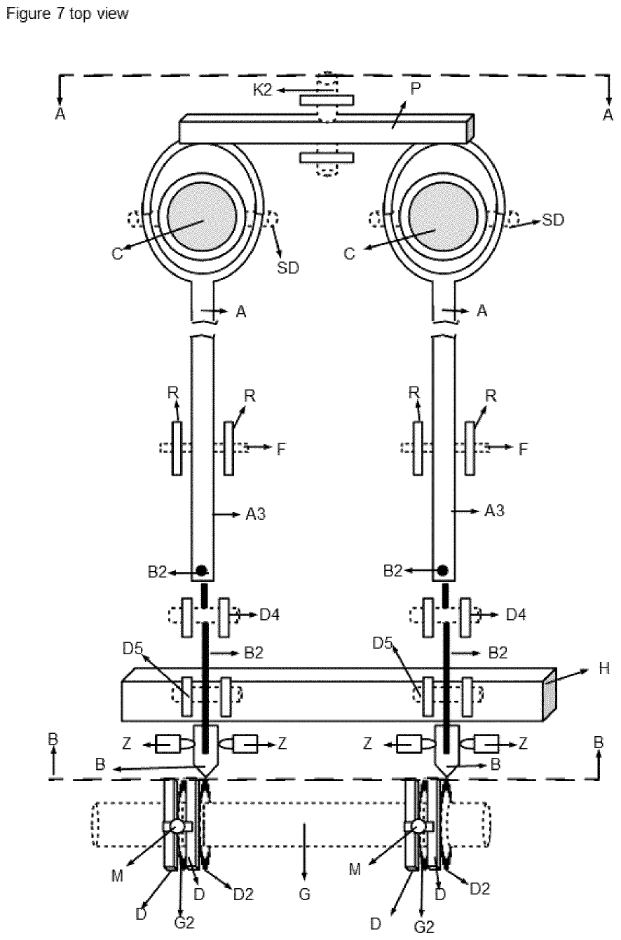

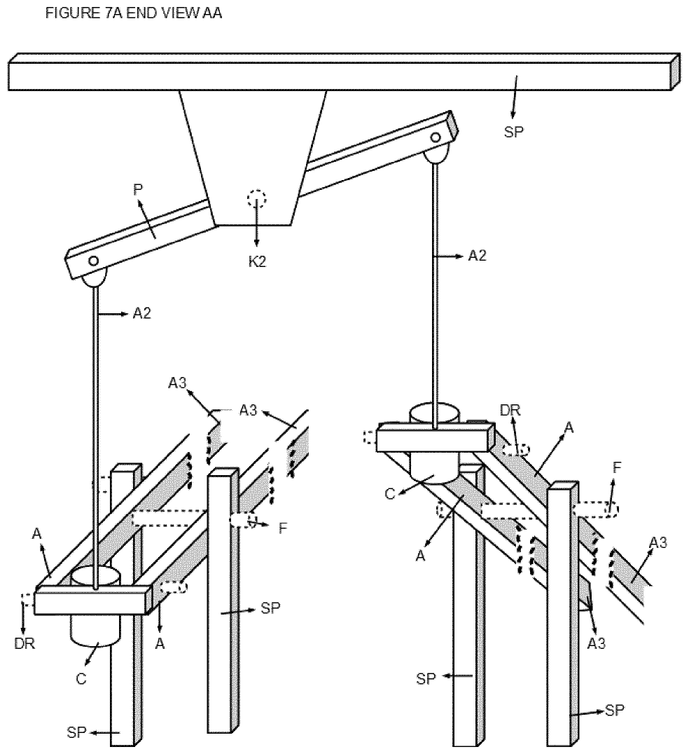

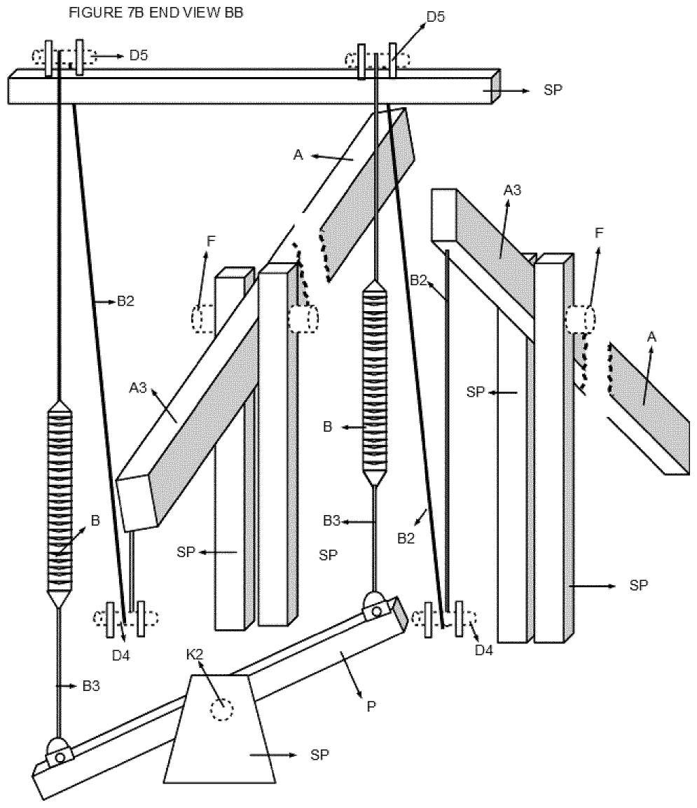

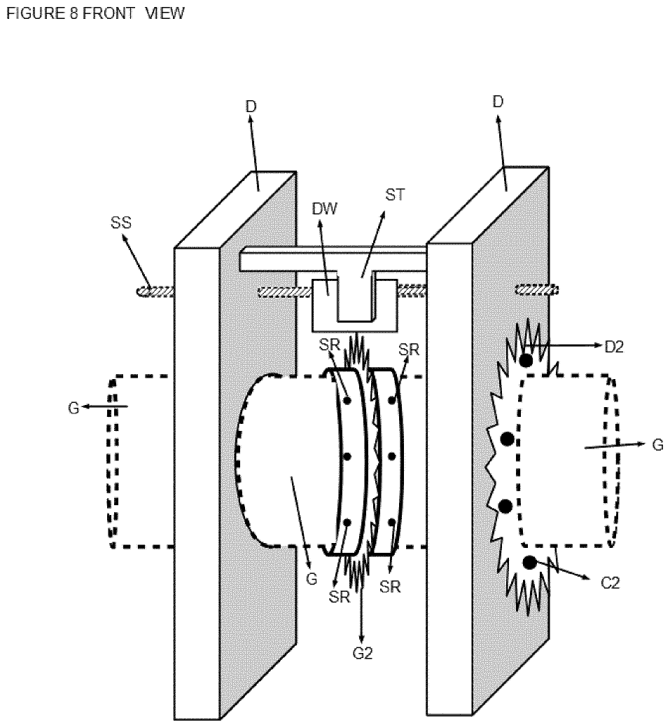

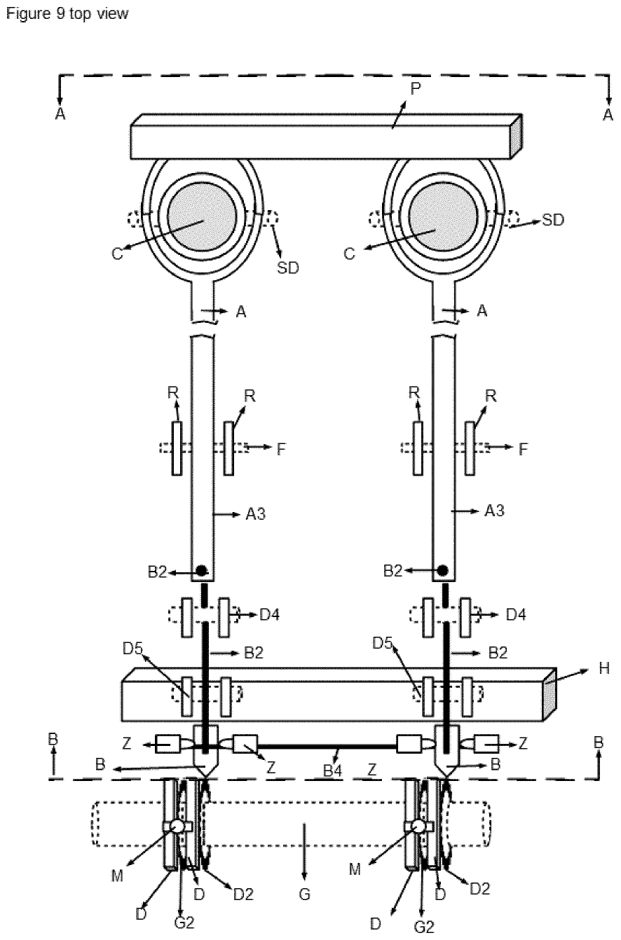

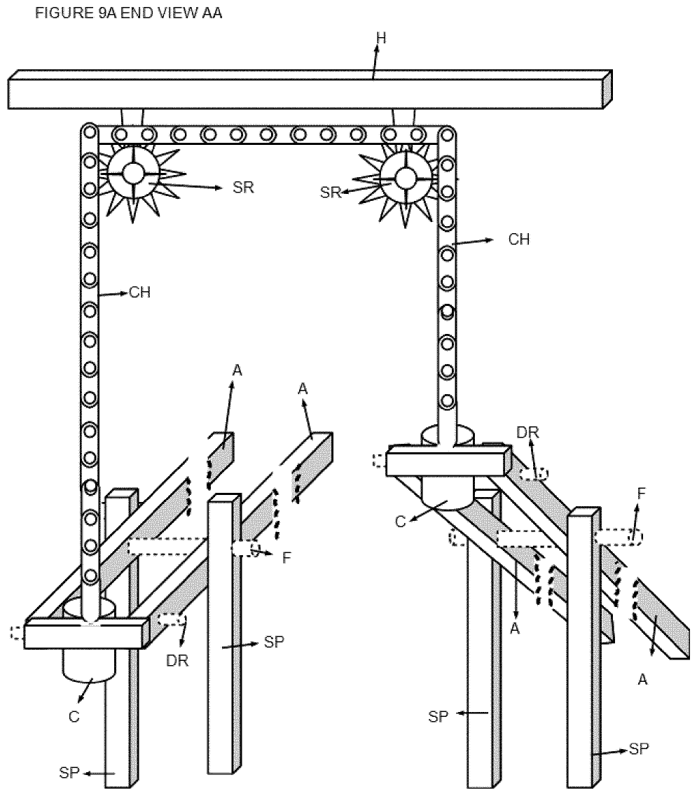

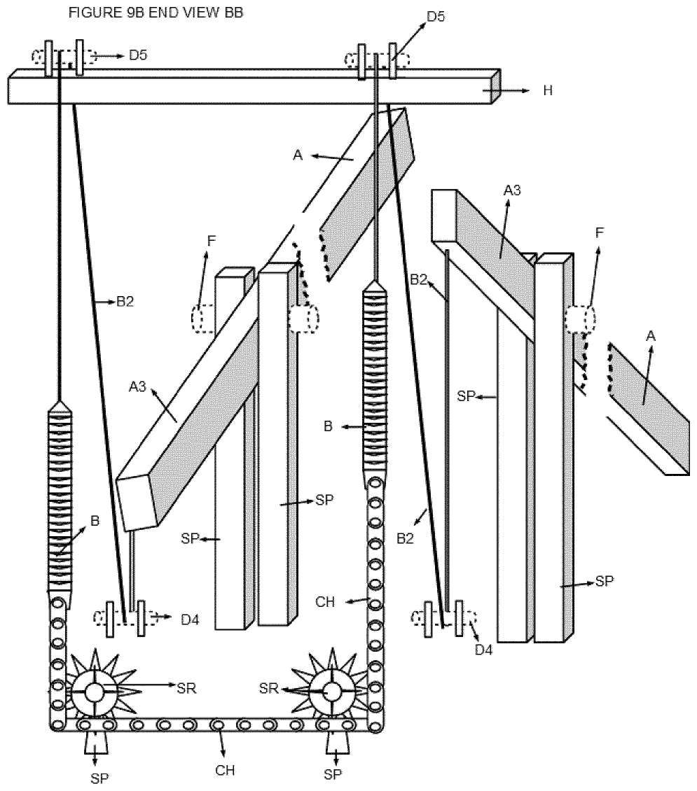

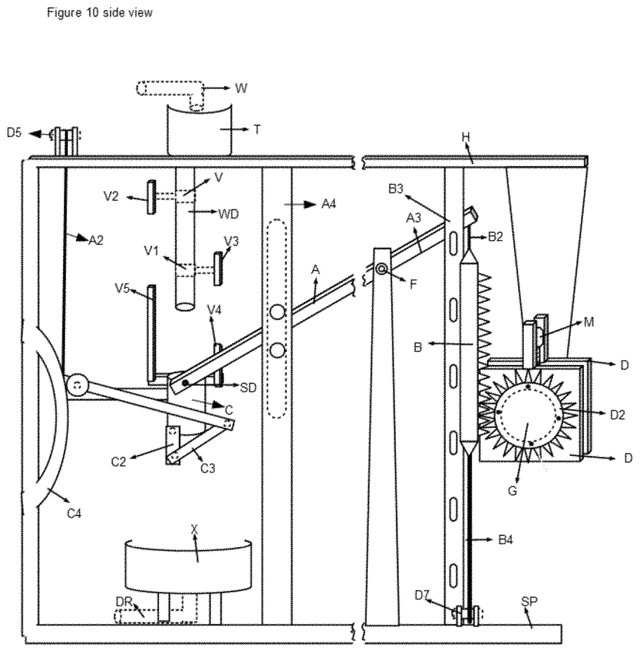

A=container end of curved lever. A2=container end of curved lever lifting cable. A3=non-container end of curved lever. A4=curved lever's roller guide.
B=rack gear. B2=rack gear's lift cable. B3=rack gear's roller guides. B4=rack gear's bottom pull down cable.
C=container. C2=containers bottom door. C3=containers bottom door opening mechanism. D=pinion gears attached blocks. D2=pinion gear. D4=lower mounted pulley. D5=upper platform mounted pulley. D6=upper platform mounted pulley. D7=lower mounted pulley. F=fulcrum. G=center shaft. M=drive wedge's lifting and lowering motor. R=support. SP=upper platform. SD=spindle.

FIG. 2 top view depicts perspective: of the preferred embodiment of the container end of lever of two side by side (adjacent) cylinders components of our water driven multiple cylinder turbine and its belt, cable or rope container end of lever lifting system. As water within one cylinder's container drive said container and its end of lever down simultaneously the cable, belt or rope (A2) is pulled around pulleys (D5) and said end of rope, belt or cable pulls said adjacent cylinder empty container end of lever is pulled up by said rope, belt or cable (D5).

The depicted side by side (adjacent) cylinders have the following components: A=container end of curved lever. A2=the container end of lever's lifting belt, rope or cable. A3=non-container end of lever. A4=curved lever's roller guide. B=rack gear. B2=rack gear's lift cable. B3=rack gear's roller guides. B4=rack gear's bottom pull down cable. C=containers. C2=containers bottom door. C3=containers bottom door opening mechanism. D5=upper platform mounted pulleys. SP=upper platform. D6=upper platform mounted pulley. D7=lower mounted pulley. SD=spindle. F=fulcrum. M=drive wedge's lifting and lowering motor. SP=upper platform. R=supports.

FIG. 2A front view AA depicts perspective: of the preferred embodiment of the set of two side by side (adjacent) cylinder's container end of lever cable counterbalancing/lifting system's components which have the following components:

A=container end of levers. A2=the container end of levers lifting cables, rope or belt. A3=section of the non-container end of lever. C=containers. D5=section of upper platform mounted pulleys. F=fulcrum. DR=spindle. H=upper platform. SP=support.
2B end view BB depicts perspective: of the preferred embodiment of two side by side (adjacent) cylinder's non-container end of lever cable counterbalancing/lifting system's components which have the following components:
section of our water driven multiple cylinder turbine with its side by side non-container end of lever's rope, belt or cable rack gear lifting system. which have the following components:
A=section of the container end of levers. A3=non-container end of lever. B=rack gears. B2=rack gear's lifting cable. B4=rack gear's bottom attached pull down rope, belt cable. D4=lower mounted pulleys. D5=upper platform mounted pulleys. D7=lower mounted pulleys. F=fulcrum. H=upper platform. SR=supports.

FIG. 4 front view depicts a non-energy producing dam as part of perspective: of the preferred embodiment of a section of our water driven megawatt energy system with water flowing over the dams three open gates and drops down into the water capture tank. Depicted are the following components:

D=non-energy producing dam. DR=section of drain tube section. PF=section of perforated section of the drain tube (DR). RC=receiver water. RW=reservoir. OG=open gates. WC=upper water capture tank. WD=gravity fed water pipe. VM=valve opening and closing motors. W=water.

FIG. 4A top view AA depicts perspective: of the preferred embodiment of four cylinder of our side by side multiple cylinder curved lever low head water driven megawatt energy system which is staged below and uses gravity fed water from the dam and into the water tank above the system. Depicted in FIG. 4. depicted are the following components:

A=container end of curved levers. A2=container end of curved levers lifting cable. A3=non-container end of the curved lever. A4=container end of curved lever's with rollers guide. B=rack gear. B2=rack gear's lift cable. B4=rack gear's bottom pull-down lifting cables.
D=pinion gear's attached set of blocks. D2=pinion gears. D4=lower mounted pulley. D5=upper platform mounted pulley. F=fulcrum. G=center shaft. G2=section of center shaft's (G)'s attached drive gears. GG=gearboxes input shaft's smaller diameter gear than the diameter of the drive shaft's attached gear's with the same pitch. GB=gearbox. GN=megawatt generator. M=drive wedge's lift and lowering motor. R=support. SP=upper platforms. T=water tank. X=under the turbine water capture tank. Z=rack gear's roller guides. WD=section of the gravity fed water pipe.

FIG. 4B side view BB depicts perspective: of the preferred embodiment of one cylinder of the side by side cylinders of our water driven curved lever low head multiple cylinder megawatt energy system on a section of the ground near the dam depicted in FIG. 4 which has a in-ground channel. Depicted are the following components:

A=container end of the curved lever. A2=container end of lever lifting cable. A3=non-container end of the curved lever. A4=curved lever's roller guide. B=rack gear. B2=rack gear's lift cable. B3=rack gear's guides with rollers. B4=rack gear's bottom attached pull down cable. C=container. C2=container's bottom door. C3=container's bottom door opening and closing mechanism. C4=containers bottom door opening and closing mechanism contact. D=blocks set with attached pinion gear. D2=pinion gear. D4=lower mounted pulley. D5=upper platform mounted pulley. D6=upper platform mounted pulley. D7=in chamber lower mounted pulley. F=fulcrum. G=center shaft. GB=section of the ground. M=set of block's mounted drive wedge's lift and lowering motor. R=support. SP=upper platform. SD=spindle. T=section of a water tank. V=gravity water delivery tubes (WDT)'s valve. V2=(WDT)'s valve opening and closing motors. W=section of the gravity fed water pipe. WT=water delivery tubes (WDT). X=section of a under turbine water capture tank. DR=section of a drain tube. CH=section of in-ground chamber.

FIG. 5 front view depicts perspective: of the preferred embodiment of a waterfall as a section of our water driven curved lever low head multiple cylinder megawatt energy system. Depicted are the following components:

WD=section of the gravity fed water delivery pipe. VM=water delivery pipe's valve opening and closing motors. RW=river or lake. DR=section of the drain line. PF=perforated section of the drain line (DR). RC=receiver water. WC=water collection bowl. W=water.

FIG. 5A side view AA depicts perspective: of the preferred embodiment of the top view section of four cylinders of our water driven curved lever low head multiple cylinder megawatt energy system. Depicted are the following components:

A=container end of curved levers. A2=container end of curved levers lifting cable. A3=non-container end of the curved lever. A4=container end of curved lever's with rollers guide. B=rack gear. B2=rack gear's lift cable. B4=rack gear's bottom pull-down lifting cables.
D=pinion gear's attached set of blocks. D2=pinion gears. D4=lower mounted pulley. D5=upper platform mounted pulley. F=fulcrum. G=center shaft. G2=section of center shaft's (G)'s attached drive gears. GG=gearboxes input shaft's smaller diameter gear than the diameter of the drive shaft's attached gear's with the same pitch. GB=gearbox. GN=megawatt generator. M=drive wedge's lift and lowering motor. R=support. SP=upper platforms. T=water tank. X=under the turbine water capture tank. Z=rack gear's roller guides. WD=section of the gravity fed water pipe.

FIG. 5B side view BB depicts perspective: of the preferred embodiment of one cylinder of our water driven curved lever low head multiple cylinder turbine megawatt energy system on a section of the ground with a in-ground channel below the rack gear section of the system which has the following components:

A=curved lever. A2=container end of curved lever lifting cable. A4=curved lever's roller guide. A3=non-container end of curved lever. B=rack gear. B2=rack gears lift cable. B3=rack gear roller guides. B4=bottom rack gear pull down cable.
C=container. C2=container's bottom door. C3=container's bottom door opening and spring closing mechanism. C4=container's bottom door opening and spring closing arm. CH=in-ground chamber. D=set of blocks. D2=set of blocks attached pinion gear. D4=in-chambers lower pulley. D5=upper pulley. D6=upper pulley. D7=in-chambers lower pulley. F=fulcrum. G=center shaft. M=drive wedge's lifting and lowering motor. R=support. SP=upper platform. SD=spindle. T=section of a water tank. V=water delivery tubes (WDT) valve. V2=valve opening and closing motor. WT=water delivery tubes (WDT). X=section of a water capture tank. DR=section of a drain tube. X=section of a water capture tank. DR=drain tube.

FIG. 7 top view depicts perspective: of the preferred embodiment of two side by side (adjacent) cylinders of our water driven multiple cylinder turbine. With a pivoting lever container end of lever lifting mechanisms and the rack gear's pivoting lever pull down mechanisms.

The depicted cylinders has the following components:

A=container end of lever. A3=non-container end of lever. B=rack gear. B2=rack gear's lifting cable. B4=rack gear's pivoting lever. C=container. D=set of blocks. D2=set of block's attached pinion gear. D4=lower mounted pulleys. D5=upper platform mounted pulleys. G=section of the center shaft. G2=center shaft's attached drive gears. H=upper platform. SD=spindle. F=fulcrum. M=drive wedge's lifting and lowering motor. P=container end of lever lifting pivoting lever. R=supports. Z=rack gear's guides roller. K2=pivoting lever's pivoting shaft.

FIG. 7A end view AA depicts perspective: of the preferred embodiment of two side by side (adjacent) cylinder's container end of levers section With a pivoting lever container end of lever lifting mechanisms system which has the following components:

A=container end of levers. A2=container end of levers lifting rod or cable. A3=a section of the non-container end of lever. C=containers. F=fulcrum. K2=pivoting lever's pivoting shaft. P=pivoting lever. DR=spindles. SP=upper platform.

FIG. 7B end view BB depicts perspective: of the preferred embodiment of the non-container end of lever of two side by side (adjacent) cylinders of our water driven multiple cylinder turbine with the rack gear's pull down pivoting lever mechanisms system which has the following components:

A=section of the container end of lever. A3=non-container end of lever. B=rack gear. B2=rack gear lifting cable. B3=rack gear's bottom attached pull down cable or rod. D4=lower mounted pulleys. D5=upper platform mounted pulleys. F=fulcrum. K2=pivoting lever's pivoting shaft. P=pivoting lever. H=upper platform. SP=supports.

FIG. 8 side view depicts perspective: of the preferred embodiment of a section of the turbine's center shaft with one of the center shaft's attached and drive gear's and the drive wedge with spring pushing point of the drive wedge into the teeth of said drive gear which drives said drive gear and said center shaft to rotate in one direction. Said spring allows point to float over the teeth of said drive gear when set of blocks and its attached pinion gear rotates in reverse around said center shaft. The depicted components are as follows:

C2=pins attaching pinion gear to one side of the set of blocks. D2=pinion gear. DW=drive wedge. G=center shaft. G2=section of the center shaft's attached drive gear. SS=spring driven rotating spindle. SR=pins attaching section of the center shaft's attached drive gear to said section of the center shaft. ST=drive wedge's stop.

FIG. 9 top view depicts perspective: of the preferred embodiment of two side by side (adjacent) cylinders of our water driven multiple cylinder turbine with the container end of lever lifting sprocket and chain mechanism system and the rack gear's bottom attached pulled down sprocket and chain pull down mechanism system The depicted components are as follows:

A=container end of lever. A3=non-container end of lever. B=rack gear. B=rack gear's lifting cable. F=fulcrum. D=set of blocks. D2=set of blocks attached pinion gear. D5=upper platform mounted pulleys. D4=lower mounted pulley’ C=containers. D=set of blocks. D2=set of block's attached pinion gear. H=upper platform. M=drive wedge's lifting and push down motor. G=center shaft. G2=center shaft's attached drive gear. SD=spindles.

FIG. 9A end view AA depicts perspective: of the preferred embodiment of two side by side (adjacent) cylinders of our water driven multiple cylinder turbine with the container end of lever lifting sprocket and chain mechanism system. Depicted are:

A=container end of lever. A3=a section of the non-container end of lever. C=containers. B=rack gears. B2=rack gear's lifting cables. F=fulcrum. CH=chain. D4=lower mounted pulleys. SR=lower mounted sprockets. H=upper platform. SS=sprockets supports. SP=support.
A=section of container end of lever. A3=a section of the non-container end of lever.

FIG. 9B end view BB depicts perspective: of the preferred embodiment of two side by side (adjacent) cylinders of our water driven multiple cylinder turbine with the non-container end of lever rack gear pulling down sprocket and chain mechanism system. Depicted are:

FIG. 10 side view depicts perspective: of the preferred embodiment of one of the side by side (adjacent) cylinders of our water driven multiple cylinder turbine megawatt energy system with a water delivery tube with manually opening and spring closing upper and lower valves. Which has the following components: A=the container end of the lever. A2=container section of the lever's lifting cable. A3=the non-container end of said lever. A4=said levers guide with rollers. B=rack gear. B2=rack gear's lifting cable. B3=rack gear's guide with rollers. B4=section of the rack gears bottom attached pull down cable. C=container. C2=container's mechanically opening and closing bottom door. C4=container's bottom door's arm. C3=container's bottom door's manually opening and closing mechanism. D=set of blocks. D2=set of block's attached pinion gears. D5=upper platform mounted pulley. F=fulcrum. G=center shaft. H=upper platform. D7=lower mounted pulley. DR=section of the drain tube. M=center shafts attached drive gears drive wedge's lowering and lifting motor. T=section of a water tank. V=spring closing upper valves. V1=spring closing lower valve. V2=upper valve's opening handle. V3=lower valve's opening handle. V4=lower valve's mechanically opening and closing drive arm. V5=upper valve's mechanically opening drive arm. WD=water delivery tube. WD=fluid or liquid delivery tube. X=section of fluid or liquid capture tank. SD=spindles. SP=supports.

What is claim:

1. A gravity, fluid or liquid driven multiple cylinder turbine for generating rpm and torque, said gravity, fluid or liquid driven multiple cylinder turbine is designed with side by side (adjacent) cylinders, said gravity, fluid or liquid driven multiple cylinder turbine has a center shaft with attached drive gears, said side by side (adjacent) cylinders comprising at least one lever with a fulcrum along the length of said levers, on one side of said fulcrum said lever has spindles at or near one end of said lever, at least one container which rotate on said spindles to maintain that said container's top is in the up position and said container's bottom doors are in the down position, container end of said lever has the end of a cable, rope or belt attached, said cable, rope or belt body is around upper pulleys, opposite end said lever (non-container end) has one end of a cable attached, said cable's body is around at least one pulley, opposite end of said cable is attached to the top of a rack gear, said rack gear's teeth mash with the teeth of a pinion gear, said rack gear had bottom attached cable, rope or belt, a section of said center shaft with at least one attached drive gears, said pinion gear is attached to a set of blocks, upper and lower pulleys, upper and lower platforms, motor or spring driven up and down into the teeth of said center shaft's attached drive gears drive wedge, said rack gears guides with rollers, said lever guides, said gravity, fluid or liquid driven multiple cylinder turbines are designed such that each two side by side (adjacent) cylinder's operate together to drive said center shaft and it's attached drive gears to rotate in that one said side by side cylinder's container end of lever on one side of said fulcrum is in the up position with said lever's non-container end is in the down position and said cylinders rack gear in the down position with said racks gears top teeth mashed with said cylinders pinion gear and the second side by side cylinder's container end of lever on one side of said fulcrum is in the down position and said lever's non-container end of said lever is in the up position with said cylinder's rack gear in the up position and said rack gear's bottom teeth mash with the teeth of said cylinder's pinion gear, said two side by side cylinders has one end of a cable, rope or belts attached to both said side by side cylinder's container ends of said levers with the body of said cable, rope, or belt around upper pulleys such that as one side by side cylinder's container end of lever in the up position with water dropped into said lever's container with said cylinder's drive wedge's point pushed into the teeth of said cylinder's section of center shaft's attached drive gear said container end of lever drops generating torque minus drag through said non-container end of said lever and remaining said cylinder's components, said rope or belt pulls said second side by side cylinder's empty container end of lever in the down position up as said empty container's bottom doors close, as said cylinder's water filled container end of lever drops a cable attached to said non-container end of said lever rises pulling the end of a cable up, said cable's body is pulled around at least one lower pulley and then around at least one upper pulley, opposite end of said cable is attached to the top of said cylinder's rack gear pulling said rack gear up, teeth of said rack gear mash with the teeth of said cylinder's pinion gear driving said pinion gear and it's attached set of blocks to rotate around said cylinder's section of said center shaft, said cable attached to the bottom of said cylinder's rising rack gear is pulled around pulleys, opposite end of said cable attached to second side by side cylinder's rack gear, said cable pulls down said rack gear, teeth of said pulled down rack gear mash with said cylinder's pinion gear's teeth, said point of said cylinder's drive wedge pulled from the teeth of said cylinder's section of said center shaft's attached drive gear said pulled rack gear driving said pinion gear and it's attached set of blocks to rotate in reverse around said cylinder's section of said center shaft, said cable one end attached to the top of said pulled down rack gear and said cable's opposite end attached to said cylinder's non-container end of lever said cable pulls said cylinder's non-container end of lever on one side of said fulcrum, said cylinder's dropping water filled container end of lever drops to a set point said water filed container door's open and said water within said container drops out, at least one of said center shaft's attached drive gear's teeth mash with the teeth of a device's input shaft's attached gear, said device's input shaft's attached gear's diameter can be less than, equal to or greater than the diameter of said center shaft's attached drive gear.

2. said rpm and torque minus drag generated by said multiple cylinder turbine defined in claim 1 being said container end of said lever on one side of said fulcrum being longer than said lever's non-container end of said lever on the opposite side of said fulcrum said torque=volume of water within said cylinder's lever's containers which said levers container end are dropping times the length of said water filled container's lever end from said fulcrum to said dropping levers container of water minus the length of said lever's non-container end times the number of cylinder's lever's and their containers of water which are simultaneously dropping. Said turbine's generated rpm minus drag can be increased when said device's input shaft's attached gear's diameter is smaller than said diameter of said center shaft's attached drive gear mashed with said device's input shaft's attached gear and when said center shaft's attached drive gear's pitch is the same as said device's input shaft's attached gear's pitch,
